(19) United States
(12) Patent Application Publication
(10) Pub. No.: US 2021/0042909 A1
(43) Pub. Date: Feb. 11, 2021

(54) IMAGING SYSTEM FOR SURFACE INSPECTION

(71) Applicant: Kimball Electronics Indiana, Inc., Jasper, IN (US)

(72) Inventors: Sangtaek Kim, San Jose, CA (US); Yan Cheng, San Jose, CA (US)

(21) Appl. No.: 16/941,672

(22) Filed: Jul. 29, 2020

Related U.S. Application Data
(60) Provisional application No. 62/883,924, filed on Aug. 7, 2019.

(51) Int. Cl. G06T 7/00; G09G 3/00

(52) U.S. Cl. CPC G06T 7/0004; G06T 2207/30121; G09G 2320/0233; G09G 3/006

(57) ABSTRACT

An imaging system and method evaluates non-uniformity or irregularity in reflective displays, such as assembled display modules of the type found in smartphones, tablets and the like. The system includes an incoherent light, such as a light-emitting diode (LED), which is polarized and collimated. The surface to be evaluated is perpendicular to the collimated light, such that the light impinges directly upon the surface. The polarization of the light is altered before and after reflection, and the reflected light from the surface under evaluation is received by a sensor. Non-uniformity or irregularity of the surface will appear in the sensed image as contrast variation. Because the reflection from the surface under evaluation is a 180-degree reflection, the sensed image can be in sharp focus across the entire surface to be evaluated. Optionally, the system may utilize a single collimation lens without a collection lens for efficiency and compactness.

### CROSS-REFERENCE TO RELATED APPLICATION

This application claims the benefit under Title 35, U.S.C. § 119(e) of U.S. Provisional Patent Application Ser. No. 62/883,924, entitled IMAGING SYSTEM FOR SURFACE INSPECTION, filed on Aug. 7, 2019, the entire disclosure of which is hereby expressly incorporated herein by reference.

### BACKGROUND

### 1. Technical Field.

The present application relates to testing and detecting surface irregularity of flat and reflective optical elements and displays, and more specifically to evaluation of the planarity or regularity of displays and assembled display modules.

### 2. Description of the Related Art.

The waviness, or lack of planarity, of a flat panel display is an important parameter for providing insight into lamination process control and for providing an indication of final product quality. It is becoming increasingly important for the display module to have a consistently high degree of planarity (i.e., flatness). Irregularities in the planarity (e.g., waviness) can be seen by an end-user of the display module, especially if seen at a specific angle. Waviness or other irregularities will consequently degrade the user experience.

What is needed is an improvement over the foregoing.

### SUMMARY

The present disclosure is directed to an imaging system and method for evaluating non-uniformity or irregularity in reflective displays, such as assembled display modules of the type found in smartphones, tablets and the like. The system includes an incoherent light, such as a light-emitting diode (LED), which is polarized. The surface to be evaluated is perpendicular to the incoming light, such that the light impinges directly upon the surface. The polarization of the light is altered before and after reflection, and the reflected light from the surface under evaluation is received by a sensor to form an image. Non-uniformity or irregularity of the surface will appear in the sensed image as contrast variation. Because the reflection from the surface under evaluation is a 180-degree reflection, the sensed image can be in sharp focus across the entire surface to be evaluated. Optionally, the system may utilize a single collimation lens without a collection lens for efficiency and compactness.

In a first system and method, incoherent light is passed through a polarizing beam splitter and shines directly (i.e., perpendicularly) upon a surface to be evaluated, which may be an assembled display module. The light reflected from the display module switches polarization by 90 degrees, and is then reflected by the polarizing beam splitter by 90-degrees. The light then passes a knife edge or aperture on its way to a camera or imaging sensor, which images the display module via the reflected light. Any non-uniform surface irregularities create contrast variation in the image of the display module, which facilitates visualization of any irregularities in the evaluated surface.

In the second system and method, incoherent light is passed through a first linear polarizer, then through a non-polarizing beam splitter, and then shines directly (i.e., perpendicularly) upon a surface to be evaluated, which may be an assembled display module. The light reflected from the display module switches polarization by 90 degrees, and is then reflected by the non-polarizing beam splitter. The light then passes a second polarizer and a knife edge or aperture on its way to a camera or imaging sensor, which images the display module via the reflected light. Any non-uniform surface irregularities create contrast variation in the image of the display module, which facilitates visualization of any irregularities in the evaluated surface.

In the third method, a similar arrangement to the second method is used with the addition of a cylindrical lens after the collimation lens, so that it generates a 1D converging wavefront. When the radius of wavefront is identical to the radius of a curved surface to be evaluated, this geometry can generate the same Schlieren-type image used in the first and second methods and apparatuses because the reflected light from the evaluated surface will follow the same ray path as the reflection from the planar displays described above, after passing the cylindrical lens both before and after reflection.

In one embodiment, the present disclosure provides an imaging system including an incoherent light source emitting an incoherent light signal, a collimation lens positioned to receive one of the incoherent light signal and the first light signal, the collimation lens emitting a collimated light signal, a polarizer functionally disposed between the incoherent light source and a sensor, and the sensor having a sensor lens defining a sensor lens plane positioned substantially perpendicular to the incoherent light signal emitted by the light source, the sensor positioned to receive a reflection of the collimated light signal.

In another embodiment, the present disclosure provides a method for evaluating imperfections in an evaluated surface, the method including emitting an incoherent light signal, passing the incoherent light signal through a beam splitter to create a first light signal and a second light signal, the first light signal angled relative to the second light signal, passing at least a portion of the incoherent light signal through a collimation lens to create a collimated light signal, reflecting the collimated light signal on the evaluated surface to create a reflected light signal, the evaluated surface defining an evaluated-surface plane substantially perpendicular to the collimated light signal, and sensing the reflected light signal on a sensor to create a sensed image.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic view of a first surface irregularity detection system made in accordance with the present disclosure, utilizing two lenses and a polarizing beam splitter;

FIG. 2 a schematic view of a second surface irregularity detection system made in accordance with the present disclosure, utilizing a single collimation lens, at least one linear polarizer, and a non-polarizing beam splitter;

FIG. 3 is a schematic view of the system shown in FIG. 2, with an alternative arrangement in which sensor and light source are interchanged;

FIG. 4 is a schematic view of the system shown in FIG. 3, with an alternative arrangement in which a cylindrical lens is utilized for evaluation of a curved display module;

FIG. 5 is a flow chart showing a method for evaluating perfections in an evaluated surface in accordance with the present disclosure;

FIG. 6A is a perspective, exploded view of a display module in accordance with the present disclosure; and

FIG. 6B is a schematic view of the display module shown in FIG. 6A.

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise form disclosed.

### DETAILED DESCRIPTION

The present disclosure is directed to methods for inspecting and evaluating display module waviness or other surface irregularity using Schlieren-type imaging. A test object is directly (i.e. perpendicularly) exposed to incoherent light which has been linearly polarized and collimated. This conditioned light signal is then reflected from a reflective surface on or integrated into the test object, and the reflected light polarization is rotated by 90 degrees by double passing through a clear quarter wave pane integrated into a polarizer laminated onto the display module. An imaging camera images this reflected light signal after further polarization filtering of the light signal. Because the plane of the test object's evaluated surface is presented directly to the light signal and is parallel with the lens of the imaging camera, the evaluation image is undistorted and therefore may be in sharp focus across the entire area of evaluation. This, in turn, results in highly effective and efficient detection and quantification of waviness or other irregularities.

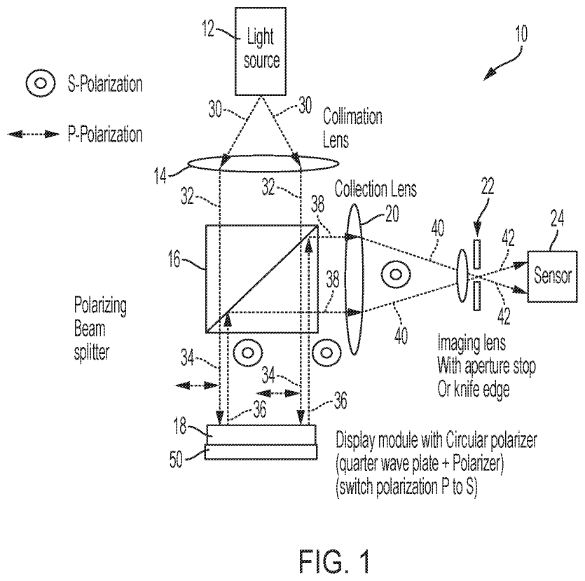

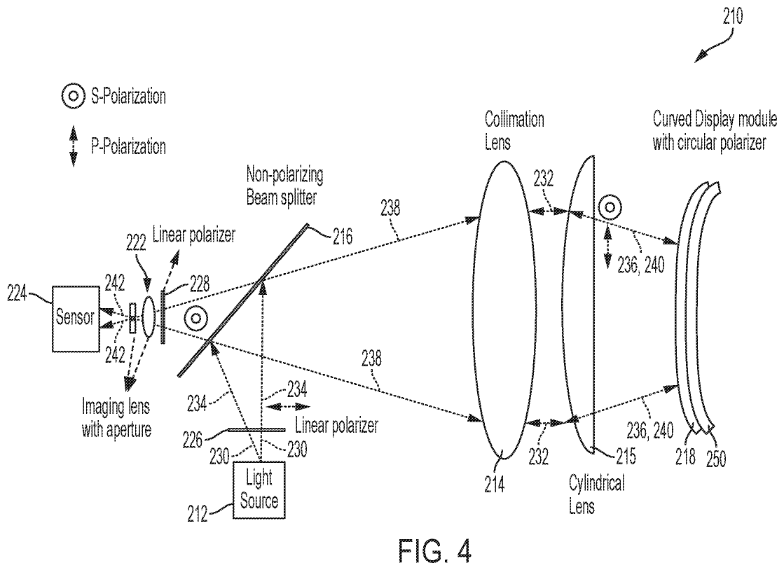

FIGS. 1-4 show block diagrams of irregularity detection systems 10, 110, 110′, 210 which are all configured to detect surface irregularities, variations in thickness, and/or variations in refractivity of a transparent optical material (e.g., covered glass or touch panels of the type used for smartphones and tablets, display cover glass, thin film, optical thin film material, etc.). Each of systems 10, 110, 110′ and 210 utilize Schlieren imaging principle to detect surface irregularity caused by a variation in flatness (or nominal curvature in the case of FIG. 4), a variation in thickness, and/or a variation in the refractive index of the transparent optical material. Thus, the presence and extent of surface waviness or irregularity in an evaluated surface can be detected and analyzed with irregularity detection systems 10, 110, 110′ and 210.

Turning now to FIG. 1, irregularity detection system 10 utilizes a folded schlieren imaging system in which polarizing beam splitter 16 splits a light path and implements polarization switching to image the illumination profile of an object, such as display module 50.

In particular, a non-collimated or incoherent light source 12, which may be an LED light fixture, for example, emits incoherent light signal 30 which is then collimated by collimation lens 14. The resulting collimated light signal 32 passes through polarizing beam splitter 16 to produce P-polarized light signal 34.

P-polarized light signal 34 is then reflected 180 degrees by display module 50, making a double pass circular polarizer 18, which includes a quarter wave plate and a linear polarizer. Light reflected from the linear polarizer makes a double pass through the quarter wave plate. In the illustrated embodiment, circular polarizer 18 is integrated into display module 50. The resulting signal reflected from display module 50 is S-polarized light signal 36, which reenters polarizing beam splitter 16 and is again reflected, this time by 90 degrees, to become reflected light signal 38 which remains S-polarized.

Reflected light signal 38 then passes through collection lens 20, remaining in an S-polarized signal configuration. The resulting collected light signal 40 is then directed to imaging lens 22, which has an aperture stop positioned at the focal point of the collected light signal 40. Alternatively, the aperture stop in the imaging lens may be replaced with a knife edge 22 positioned to filter collected light signal 40 at the focal point. The resulting filtered light signal 42 is then received by sensor 24, which may collect and present an image indicative of the surface regularity of the reflective surface to be evaluated. In the illustrated embodiment, the evaluated surface is from display module 50, as shown and described herein.

Where waviness or other irregularities in the evaluated surface are present, detection system 10 causes incoming rays of the collected light signal 40 to be blocked by the opaque portions of the aperture stop or knife edge, while cleanly reflected rays pass the aperture stop or knife edge. In this way, system 10 creates contrast variation in the reflected image of the evaluated surface, as gathered and output by sensor 24 (e.g., to a monitor or other display module). This contrast variation is indicative of the presence and extent of waviness or surface irregularities of the evaluated surface, with larger variations in contrast corresponding to greater prevalence and/or magnitude of other irregularities, and vice versa.

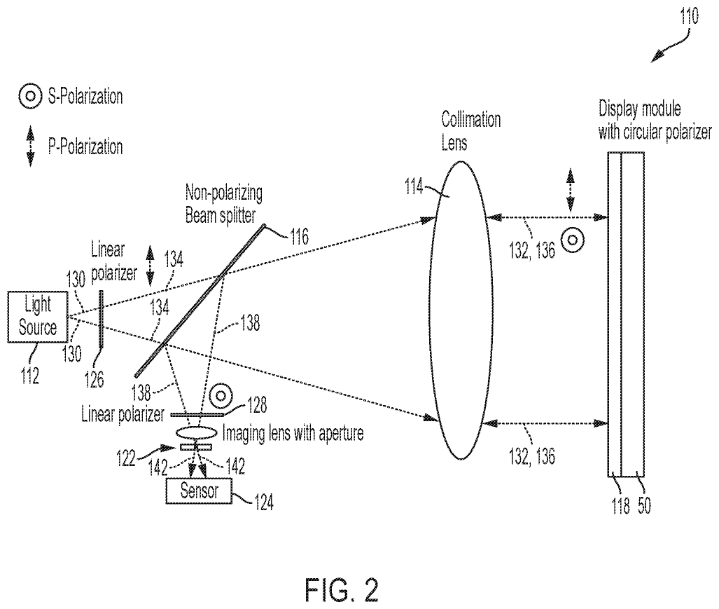

Turning now to FIG. 2, a second irregularity detection system 110 is illustrated which facilitates detection and quantification of waviness or other irregularities in a similar manner to system 10 describe above. System 110 is substantially similar to system 10 described above, with reference numerals of system 110 analogous to the reference numerals used in system 10, except with 100 added thereto. Elements of system 110 correspond to similar elements denoted by corresponding reference numerals of system 10, except as otherwise noted.

However, system 110 is reconfigured to eliminate collection lens 20, such that system 110 can be more physically compact and less expensive.

In system 110, incoherent light source 112 emits incoherent light signal 130, which is passed through a first linear polarizer 126 to create P-polarized light signal 134. Light signal 134 then passes through non-polarizing beam splitter 116 and collimation lens 114, to create collimated light signal 132 directed squarely at display module 50. That is, collimated light signal 132 is perpendicular to the plane of the evaluated surface of display module 50. Signal 132 makes a double pass through the quarter wave plate included as part of circular polarizer 118, which may be constructed similarly to polarizer 18 described above.

The resulting reflected light signal emitted from display module 50 is S-polarized light signal 136, which is oriented 180 degrees from the P-polarized collimated light signal 132. Signal 136 is directed back to non-polarizing beam splitter 116, which it is reflects signal 136 by 90 degrees. The resulting reflected light signal 138 then passes through a second linear polarizer 128, and the resulting S-polarized signal encounters imaging lens 122 having an aperture stop positioned at the focal point. As discussed above with respect to system 10, this aperture stop (or knife edge) at the focal point causes any light rays reflected by non-flat portions of the reflected surface of display module 50 to be blocked by the opaque portion of the aperture stop, thereby creating contrast with light rays reflected from the flat surface portions. Thus, the image collected by sensor 124 via light signal 142 provides contrast indicative of the presence, position and magnitude of waviness or other surface irregularities in the evaluated surface of display module 50.

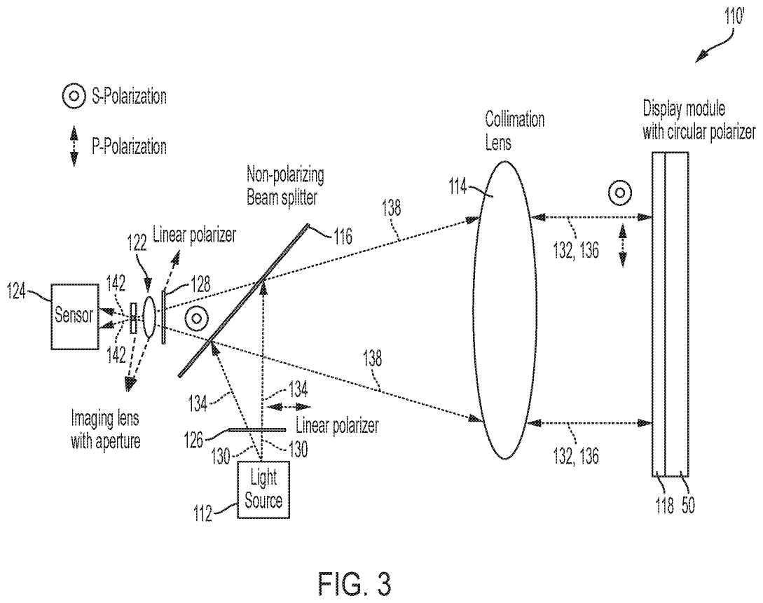

FIG. 3 shows irregularity detection system 110′ which is generally similar to structure and function to irregularity detection system 110 described in detail above. Systems 110 and 110′ are substantially similar to one another and are composed of the same constituent structures, as shown.

However, detection system 110′ interchanges the positions of light source 112 and sensor 124 relative to beam splitter 116, together with other associated components (such as aperture stop 122 and linear polarizers 126 and 128). As depicted in FIG. 3, incoherent light source 112 emits incoherent light signal 130, which passes through linear polarizer 126 to create P-polarized light signal 134. Signal 134 is then reflected 90 degrees by non-polarizing beam splitter 116. The resulting reflected signal 138 passes through collimation lens 114 creating collimated light signal 132, which is reflected from display module 50 via circular polarizer 118 in the same manner described above with respect to system 110.

The reflected S-polarized light signal 136 emitted by the evaluated surface of display module 50 then passes through non-polarizing beam splitter 116 and through the second linear polarizer 128. Imaging lens (or knife edge) 122 filters the S-polarized light signal 136, and the resulting light signal 142 is received by sensor 124. The resulting image sensed by sensor 124 has contrast indicative of the presence and extent of surface irregularities, as described above.

Referring now to FIG. 4, irregularity detection system 210 has a generally similar configuration to system 110′ described above. Moreover, system 210 is substantially similar to systems 110 and 110′ described above, with reference numerals of system 210 analogous to the reference numerals used in systems 110 and 110′, except with 100 added thereto. Elements of system 210 correspond to similar elements denoted by corresponding reference numerals of system 110, except as otherwise noted.

However, irregularity detection system 210 further includes cylindrical lens 215 which receives collimated light signal 232 from collimation lens 214. Cylindrical lens 215 passes a P-polarized, convergent light signal 240 toward curved display module 250 including circular polarizer 218. After reflection and a double pass through polarizer 218, light signal 236 is reflected from the curved evaluated surface as passes back through cylindrical lens 215 and collimation lens 214 to generate reflected light signal 238.

Convergent light signal 240 is a one-dimensional curved (i.e., focusing) wave front which is incident on the correspondingly convex curved reflective surface of display 250. The radius of the curvature of this focusing wave front equal to the intended radius of the curved convex display surface of display module 250, such that the reflected S-polarized light signal 236 reflected by the evaluated surface of module 250 is pass back through cylindrical lens 215 to become re-collimated, and then back through collimation lens 214 to become refocused toward sensor 224 as reflected light signal 238. Thus, cylindrical lens operates to create reflected light signal 238 from the curved surface of curved display module 250 that has the same Schlieren image configuration as the systems 10, 110 and 110′ designed for evaluation of flat surfaces as described in detail above. In this way, the presence and extent of irregularities of the curved evaluated surface can be assessed the same as for flat (i.e., planar) surfaces.

In the illustrated embodiment of FIG. 4, cylindrical lens 215 is a positive (i.e., focusing) cylindrical lens designed for use with a convex curved display as noted above. However, a similarly formed negative cylindrical lens may also be used to generate a similarly one-dimensional diverging wave front designed for accurate measurement of irregularities in a curved, concaved display panel.

FIG. 4 illustrates light source 212 emitting P-polarized light signal 234 via linear polarizer 226 toward the reflective surface of non-polarizing beam splitter 216, while reflected light signal 238 is directed through beam splitter 216 toward sensor 224. This configuration is similar to system 110′ shown in FIG. 3 and discussed in detail above, with the exception of the addition of cylindrical lens 215 and system 210. However, it is also contemplated that the configuration of system 110, shown in FIG. 2, may be similarly modified with the addition of cylindrical lens 215 for evaluation of curved display module 250. That is, light source 212 and sensor 224 may be interchanged with respect to beam splitter 216, together with their associated components.

In the case of systems 10 and 110 shown in FIGS. 1 and 2 respectively, light sources 12, 112 shine directly upon display module 50. That is to say, the collimated beams derived from light sources 12, 112 are perpendicular to the plane defined by the surface to be evaluated of display module 50. For purposes of the present disclosure, “substantially perpendicular” referrers to about 90 degrees, such as angles as small as 89.5, 89.7 or 89.9 degrees or as much as 90.1, 90.3 or 90.5 degrees, including exactly 90 degrees, or any range of angularity defined by any pair of the foregoing values.

By contrast, in the case of systems 110′ and 210 shown in FIGS. 3 and 4, incoherent light sources 112, 212 emit incoherent light signals 130, 230 which are nominally parallel to the respective evaluated surface planes of display modules 50 and 250, but after reflection from non-polarizing beam splitters 116, 216 and collimation, the collimated light beam again shines directly upon (i.e., is perpendicular to) the plane defined by the evaluated surface.

In this way, all of systems 10, 110, 110′ and 210 are arranged for the plane defined by the respective lens of sensors 24, 124 and 224 to be perpendicular to the incoming filtered signals 42, 142, 242 respectively. This incoming signal, in turn, is a direct reflection of the reflective surface display modules 50 or 250. Thus, sensors 24, 124 and 224 are positioned to be receive a reflected collimated light signal which is a direct, 180-degree reflection of the plane of the evaluated surface of display modules 50, 250. The entirety of the resulting image generated by sensors 24, 124 and 224 may therefore be in perfect or near-perfect focus. By contrast, a system in which the reflected image received by a sensor comes from a display module which is angled relative to the sensor lens, perfect focus is only possible across a narrow strip of the reflected image.

In the case of systems 10, 110 and 110′, the evaluated surface is a substantially planar surface, in that display module 50 presents a nominally planar surface display to a user. For purposes of the present disclosure and in the context of mobile phones and handheld tablet devices, “substantially planar” may mean a surface with nominal variations from planarity of no more than 100 μm. For these systems, contrast in the image received by sensors 24 or 124 is indicative of non-planarity or other irregularity of the evaluated surface.

On the other hand, FIG. 4 shows system 210 designed for evaluation of a curved surface of display module 250 as described above. This curved surface may still be said to define a plane of inspection similar to the planar surface of display module 50. For purposes of the present disclosure, the plane of the evaluated surface of curved module 250 is a plane perpendicular to the radius of curvature defined by the curved surface and bisecting the area of the surface to be evaluated, such that half of the curved surface is on one side of the plane and other half of the curved surface is on the other side of plane. In system 210 of FIG. 4, the image sensed by sensor 224 is indicative of imperfections in the curvature of the evaluated surface, with a “perfect” surface representing one which has perfect conformance to the desired radiused (e.g., cylindrical or spherical) surface, and imperfections representing deviations from that perfect surface.

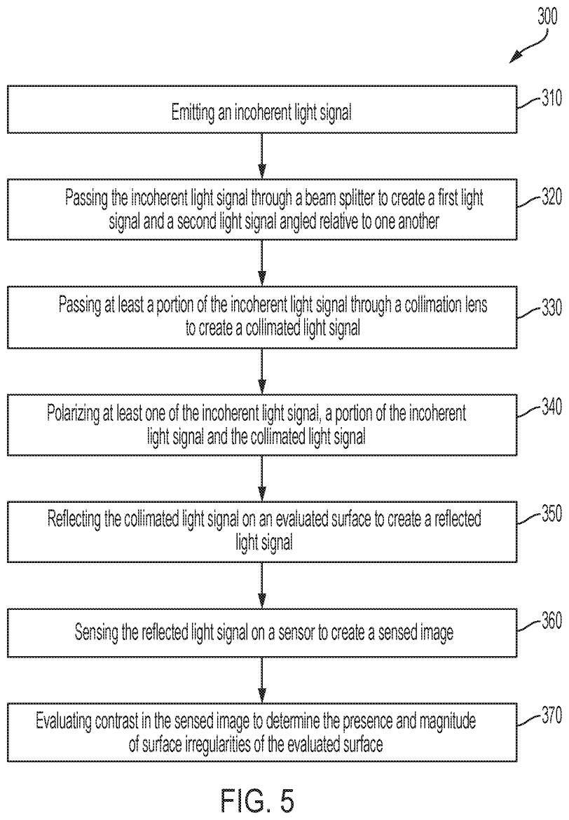

FIG. 5 illustrates an exemplary method for evaluating imperfections in an evaluated surface, whether planar (in the case of system 10, 110 or 110′), or curved (in the case of system 210). This method 300 may be performed by a human user of a system made in accordance with the present disclosure, or may be automated through the use of a computer or controller.

In embodiments, images detected by sensors 24, 124 or 224 are evaluated by a controller. In embodiments, the controller is microprocessor-based and includes a non-transitory computer readable medium which includes processing instructions stored therein that are executable by the microprocessor of controller to evaluate the detected image to determine a level of imperfection in the display surface under test. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

The image will be processed by software designed to detect and evaluate contrast variation and determine the defect size and generate scores for overall display quality. Both conventional image processing and machine learning techniques can be used to implement this software.

In step 310, an incoherent light signal is emitted, such as by applying electrical power to a light source. In an exemplary embodiment, the light signal is an LED signal coming from one of light sources 12, 112 or 212. In step 320, the incoherent light signal is passed through a beam splitter, such as polarizing beam splitter 16 or non-polarizing beam splitters 116 or 216, to create a first light signal and a second light signal angled to one another. In one exemplary embodiment, the first and second light signals may be angled by 90° relative to one another and split about 50/50, such that each of the first and second light signals are of equal or substantially equal intensity. The light passing straight through the polarized beam splitter is linearly polarized in a first direction, referred to herein as p-polarization. In the case of a non-polarizing beam splitter, the light is not polarized by the beam splitter.

In step 330, at least a portion of the incoherent light signal is passed through a collimation lens to create a collimated light signal. In some systems made in accordance with the present disclosure, such as system 10, this collimation step may occur before the incoherent light signal enters the beam splitter. In other systems made in accordance with the present disclosure, such as in systems 110, 110′ and 210, this step may occur after the light signal has passed through, or been reflected by, the beam splitter. As such, in some cases only a portion of the incoherent light signal may pass through the collimation lens.

In step 340, at least a portion of the incoherent light signal is polarized. Such polarization may be affected by one or more structures, including polarized beam splitter 16 in system 10, linear polarizers 126, 128 in systems 110, 110′, or linear polarizers 226 and 228 in system 210. In addition, each of systems 10, 110, 110′ and 210 may affect polarization of at least a portion of the incoherent light signal, whether before or after collimation, via circular polarizers 18, 118 or 218 respectively.

In step 350, the collimated light signal is reflected on an evaluated surface, such as the reflective surface of display modules 50 or 250, to create a reflected light signal. This reflected light signal is sensed by the sensor, such as sensors 24, 124 or 224, in order to create a sensed image. In step 370, this sensed image is used for an evaluation of contrast to determine the presence and magnitude of surface irregularities in the evaluated surface

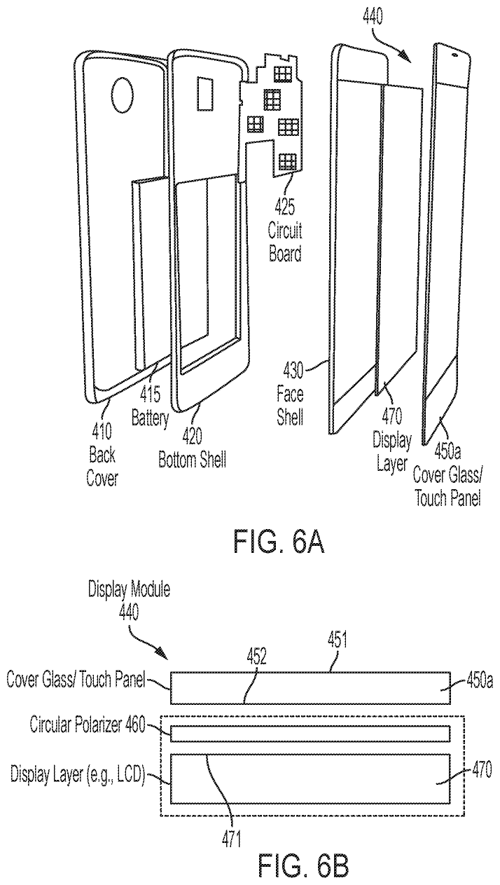

In one exemplary embodiment display modules 50, 250 may be mobile phones, tablets, or other handheld display devices, and system 10, 110, 110′ or 210 is used to evaluate the operator interface of the mobile phone or tablet. For example, FIGS. 6A and 6B illustrate mobile phone 400 which may be substituted for display modules 50 or 250 (depending on whether phone 400 has a nominally planar or nominally curved user interface).

As shown in FIG. 6A, the mobile phone 400 includes a back cover 410. A bottom shell 420 is interfaced with a face shell 430 to protect the circuit board 425 that is configured to provide functionality to the mobile phone 400. The bottom shell 420 is configured to support a battery 415, and is further configured to interface with the back cover 410. The face shell 430 is configured to interface with and support a display module 440. When fully assembled, the display module 440 includes a display layer 470 and cover glass/touch panel 450a. The cover glass/touch panel 450a is configured as a transparent material or transparent optical material 450. When interfacing together all of the various components, the mobile phone 400 is configured in a convenient package suitable for handling by human hands. A tablet may be configured similarly to phone 400, except with larger overall dimensions.

The display module 440 includes a display layer 470, such as a liquid crystal display (LCD), a circular polarizer 460, and optically transparent cover glass/touch panel 450a. In some configurations, the circular polarizer 460 may be integrated within the display layer 470 as is shown by the dotted outline surrounding both the display layer 470 and circular polarizer 460. The display layer 470 is configured to provide a visual interface with a corresponding user, such as by displaying images that are viewable by the user. The display layer 470 may include one or more additional layers, as required or desired for a particular application. Various technologies are used to build the display layer 470 typically configured as pixels providing colored light that are viewable by a user. These technologies include liquid-crystal displays (LCDs), light-emitting diodes (LEDs), organic light-emitting diodes (OLED), etc. The cover glass/touch panel 450a is located adjacent to the display layer 470 or the circular polarizer 460 that is associated with the display layer 470. Cover glass/touch panel 450a is configured as a user interface, wherein the user may interact with the mobile phone 400 and/or provide input control through touching the glass or panel 450a using a stylus or one or more finger.

Other uses of the display module 440 and/or transparent optical material 450 are contemplated, such as any mobile devices with display screens, television screens, computer monitors, tablet devices, integrated display screens (e.g., integrated into dash of vehicle, desk surface, panel, etc.), portable communication devices, etc.

In particular, uniformity of the top surface 451 of the cover glass/touch panel 450a and top surface 471 of display layer 470 is desired for optimum viewing experience of the user. Embodiments of the present disclosure, including systems 10, 110, 110′ and 210 described in detail above, are configured to detect and/or measure the flatness of the top surface 451 of cover glass 450a or other transparent material, and of the top surface 471 of display layer 470 or other reflective material.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging system comprising:
an incoherent light source emitting an incoherent light signal;
a collimation lens positioned to receive the incoherent light signal, the collimation lens emitting a collimated light signal;
a sensor having a sensor lens defining a sensor lens plane positioned substantially perpendicular to the incoherent light signal emitted by the incoherent light source, the sensor positioned to receive a reflection of the collimated light signal; and
a polarizer functionally disposed between the incoherent light source and the sensor.

2. The imaging system of claim 1, further comprising a display module having an evaluated surface defining an evaluated-surface plane, the display module positioned such that the evaluated-surface plane is substantially perpendicular to the collimated light signal.

3. The imaging system of claim 2, wherein the sensor lens plane is substantially parallel to the evaluated-surface plane and the incoherent light signal is substantially parallel to the evaluated-surface plane.

4. The imaging system of claim 2, wherein the sensor lens plane is substantially perpendicular to the evaluated-surface plane and the incoherent light signal is substantially perpendicular to the evaluated-surface plane.

5. The imaging system of claim 2, wherein the evaluated surface is a substantially planar surface, whereby an image sensed by the sensor includes contrast indicative of non-planarity of the evaluated surface.

6. The imaging system of claim 2, wherein the evaluated surface is a curved surface, the imaging system further comprising a cylindrical lens having a curvature corresponding to the curved surface, whereby an image sensed by the sensor includes contrast indicative of imperfections in the curvature of the evaluated surface.

7. The imaging system of claim 1, wherein the sensor lens comprises an aperture.

8. The imaging system of claim 1, further comprising a beam splitter positioned to split the incoherent light signal into a first light signal and a second light signal, the first light signal angled relative to the second light signal.

9. The imaging system of claim 8, wherein the polarizer comprises:
a first linear polarizer disposed between the incoherent light source and the beam splitter, wherein the beam splitter comprises a non-polarizing beam splitter; and
a second linear polarizer disposed between the sensor and the beam splitter.

10. The imaging system of claim 8, wherein the beam splitter and the polarizer are combined as a polarizing beam splitter.

11. The imaging system of claim 10, further comprising a collection lens disposed between the polarizing beam splitter and the sensor.

12. The imaging system of claim 11, wherein the sensor lens comprises one of an aperture and a knife edge.

13. The imaging system of claim 1, wherein the incoherent light signal is emitted by a light-emitting diode.

14. A method for evaluating imperfections in an evaluated surface, the method comprising:
emitting an incoherent light signal;
passing the incoherent light signal through a beam splitter to create a first light signal and a second light signal, the first light signal angled relative to the second light signal;
passing at least a portion of the incoherent light signal through a collimation lens to create a collimated light signal;
reflecting the collimated light signal on the evaluated surface to create a reflected light signal, the evaluated surface defining an evaluated-surface plane substantially perpendicular to the collimated light signal; and
sensing the reflected light signal on a sensor to create a sensed image.

15. The method of claim 14, further comprising evaluating contrast in the sensed image to determine the presence and magnitude of surface irregularities of the evaluated surface.

16. The method of claim 15, wherein the evaluated surface is a curved surface, the method further comprising:
passing the collimated light signal through a cylindrical lens to create a modified collimated light signal,
the step of reflecting comprises reflecting the modified collimated light signal on the curved evaluated surface, and
the step of evaluating contrast comprises determining the presence and extent of imperfections in a curvature of the curved evaluated surface.

17. The method of claim 15, wherein:
the evaluated surface is a substantially planar surface, and
the step of evaluating contrast comprises determining the presence and extent of non-planarity of the substantially planar surface.

18. The method of claim 14, further comprising polarizing at least one of the incoherent light signal, a portion of the incoherent light signal and the collimated light signal.

19. The method of claim 14 wherein the step of sensing the reflected light signal comprises one of:
passing the reflected light signal through one of an aperture, and
passing the reflected light signal across a knife edge.

20. The method of claim 14, further comprising:
positioning the collimation lens substantially perpendicular to at least a portion of the incoherent light signal; and
positioning the evaluated surface substantially parallel with the collimation lens.
